(19) United States
(12) Patent Application Publication
(10) Pub. No.: US 2011/0202363 A1
(43) Pub. Date: Aug. 18, 2011

(54) CONTINUING PATIENT EDUCATION PROGRAM

(76) Inventor: Cleopatra Beaton, Calabasas, CA (US)

(21) Appl. No.: 12/849,658

(22) Filed: Aug. 3, 2010

Related U.S. Application Data
(60) Provisional application No. 61/305,452, filed on Feb. 17, 2010.

(51) Int. Cl. G06Q 50/00; G06Q 30/00

(52) U.S. Cl. 705/2

(57) ABSTRACT

A standardized continuing patient education (CPE) method offers certification and incentives in exchange for sustained health status improvement and continuation of educational learning. The CPE method may create the foundations for developing an innovative method for validating individual accountability and responsibility for patients with chronic illness. The CPE method of delivery may be consistent and taught by health experts having advanced degrees. Certification and renewals through the CPE program may support sustainable self-care practices and subsequent favorable health outcomes. Reward mechanisms may be set up to provide rewards as a result of adopting responsibility and accountability for poor health practices. The CPE concept may foster patients with chronic illnesses or conditions to adopt self-care behaviors that translate to a reward mechanism over an extended demonstration of favorable health outcomes.

### CROSS REFERENCE TO RELATED APPLICATION

The present application claims the benefit of priority to U.S. provisional patent application No. 61/305,452, filed Feb. 17, 2010, which is herein incorporated by reference.

### BACKGROUND OF THE INVENTION

The present invention relates to a continuing education program and, more particularly, to a continuing education program for patients that offers certifications to persons with chronic illness.

Current patient education programs do no offer a standard method of certification and evaluation of its outcome over an extended period of time. Further, current health education programs do not contractually offer incentives for patients with chronic illness to sustain healthy practices.

As can be seen, there is a need for patent education programs that may offer initial certification and subsequent renewals through continuing patient education (CPE) programs.

### SUMMARY OF THE INVENTION

In one aspect of the present invention, a continuation patient education (CPE) program comprises at least one CPE program module adapted to provide education to a patient dealing with a health problem; at least one contract between the patient and a sponsoring organization; and a certification granted to the patient upon patient completion of the CPE program module.

In another aspect of the present invention, a method for providing standardized educational certification for patients with chronic illness comprises delivering at least one CPE program module to the patient dealing with the chronic illness; executing a contract between the patient and a sponsoring organization; and granting a certification to the patient upon patient completion of the CPE program module.

These and other features, aspects and advantages of the present invention will become better understood with reference to the following drawings, description and claims.

### BRIEF DESCRIPTION OF THE DRAWINGS

FIG. 1 is a block diagram showing a schematic representation of an exemplary embodiment of the present invention;

FIG. 2 is a flow chart describing the development of a CPE program according to an embodiment of the present invention;

FIG. 3 is a continuation of the flow chart of FIG. 2; and

FIG. 4 is a flow chart describing patient certification according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a standardized continuing patient education (CPE) method that offers certification and incentives in exchange for sustained health status improvement and continuation of educational learning. The CPE method may create the foundations for developing an innovative method for validating individual accountability and responsibility for patients with chronic illness. The CPE method of delivery may be consistent and taught by health experts having advanced degrees. Certification and renewals through the CPE program may support sustainable self-care practices and subsequent favorable health outcomes. Reward mechanisms may be set up to provide rewards as a result of adopting responsibility and accountability for poor health practices. The CPE concept may foster patients with chronic illnesses or conditions to adopt self-care behaviors that translate to a reward mechanism over an extended demonstration of favorable health outcomes.

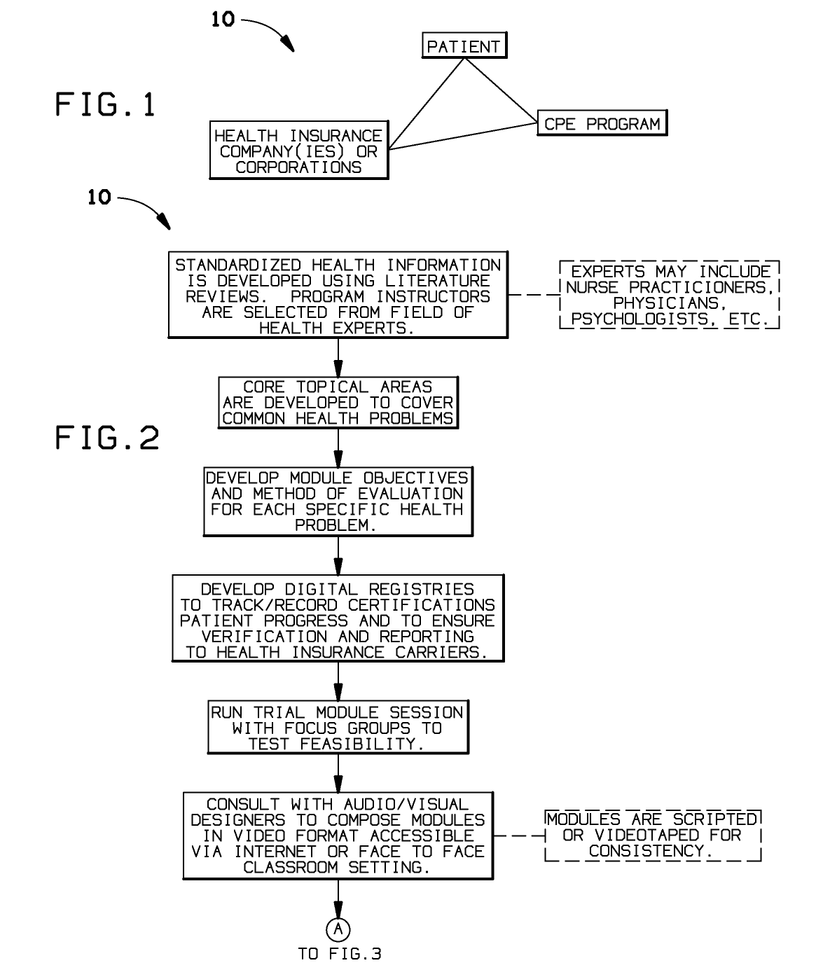

As shown in FIG. 1, the reward mechanisms for favorable healthy outcomes, as a result of the CPE program, can be achieved by creating contractual partnerships with health insurance carriers to offer discounted premiums and other incentives for sustained healthy practices and continued participation of the CPE program. The CPE program may serve as the mediator to achieve shared responsibility between health care insurance carriers (or other relevant corporations involved in healthcare) and the recipient of that healthcare coverage. Successful incentive and reward mechanisms between CPE attendees and health insurance (or other healthcare entities) do not currently exist by may be an innovative concept to remedy unstandarized patent health education.

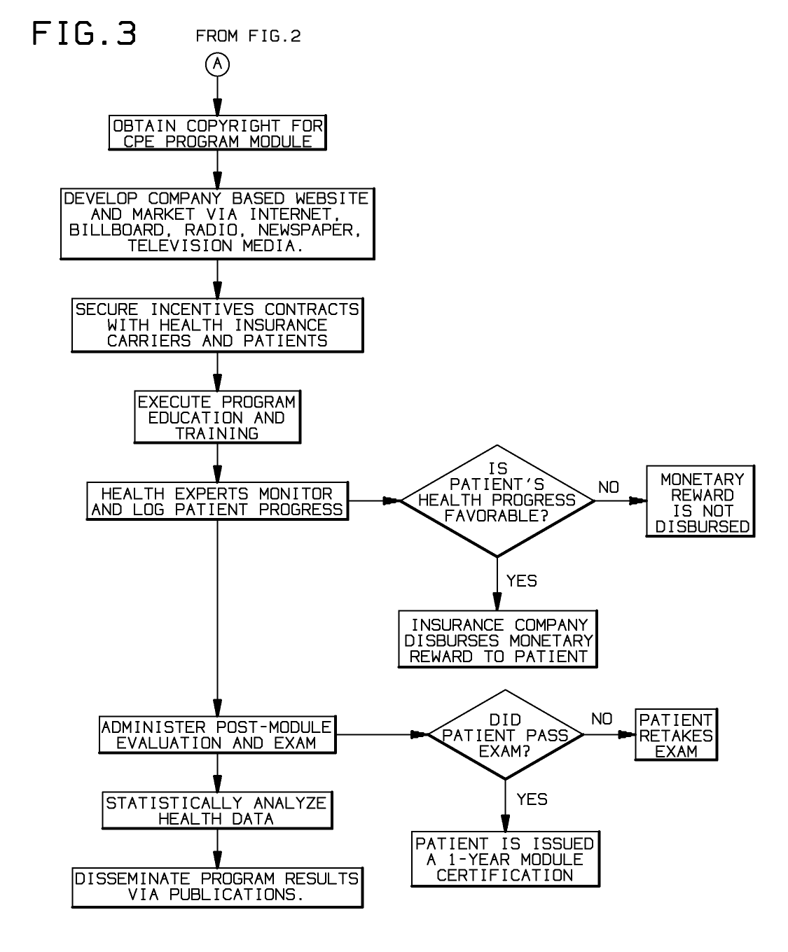

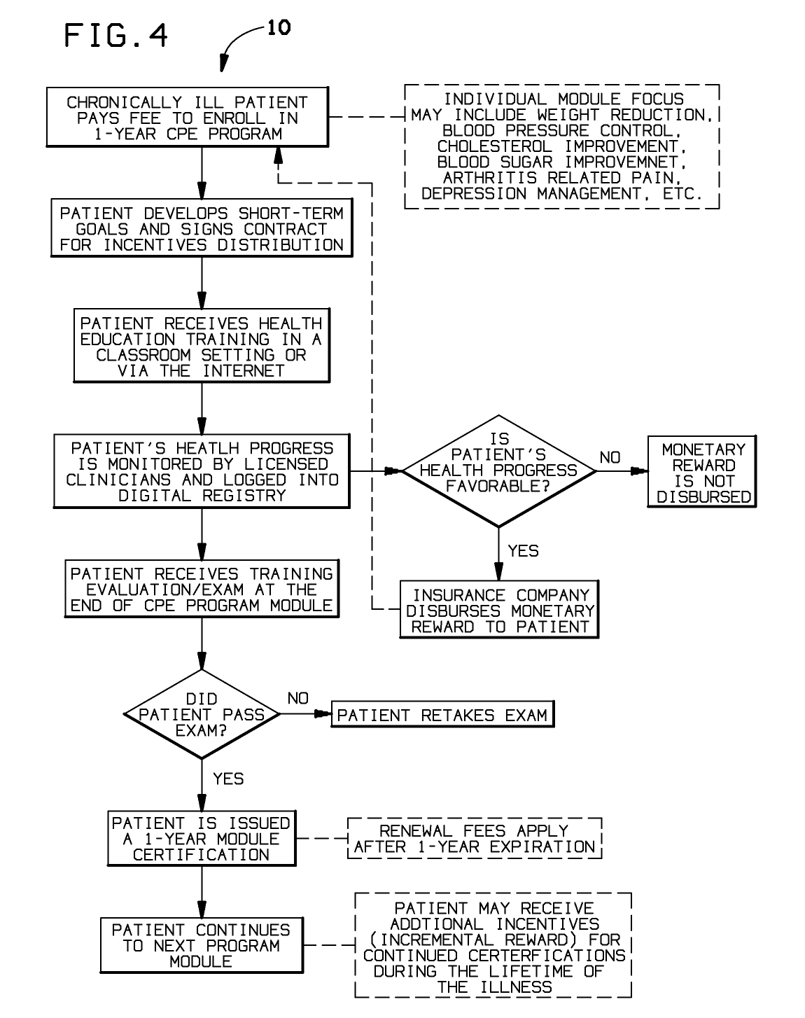

Referring to FIGS. 2 through 4, the CPE program content design may include the development of standardized health information and the formation of health expert teams (nurse practitioner, psychologists and physicians) to do the following: a) develop core topical areas to cover common health problems (obesity, hypertension, diabetes, high cholesterol, arthritis, depression, and the like); b) develop CPE module objectives and methods of evaluation for each specific health condition based on evidence-based research. Each module may be scripted or videotaped for consistency; c) run a trial CPE session with focus groups to test feasibility; d) consult with visual/audio software designers to compose modules in video format accessible via the internet or in a face to face classroom setting; and e) develop a company website and market via the internet, billboard, radio, newspaper, television, or other media outlets. Once the CPE program content is developed, contracts with health insurance carriers and participants may be secured.

The CPE program may be implemented by nurse practitioners, physician, psychologists or other healthcare professionals. The CPE program may require an annual enrollment fee to attend certain modules. At each module completion, attendees may receive post-test evaluations and, upon passing an exam, appropriate certifications with specific expiration dates may be dispensed. For each module, attendees may develop and contractually sign short-term achievable goals, specifying date of achievement. The goals may include, for example, a specified weight, blood pressure, cholesterol, fasting blood sugar, state of mood, tolerable pain state, physical capacity, or the like. Licensed clinicians may have access to the attendees' goal achievement. Software registries may be developed to tract record certifications, track patient progress and ensure methods of verification and reporting to health insurance carriers. The CPE program may include steps for improving program quality to ensure program efficiency. Quality improvement data may be disseminated via publication and media.

Typically, program instructors are selected to be health experts only (nurse practitioner, physicians and psychologist) because these professionals are familiar with patients' learning needs and clinical manifestations of commonly seen chronic illnesses. Hence, these experts will also better evaluate the progress of every CPE attendees.

Once CPE program module is developed, copyrighted, and marketed, potential users can opt to attend CPE program via satellite web-site or face to face interactions in pre-determined learning sites. Attendees and participating entities (healthcare insurance carriers or other form of healthcare entities) must engage in a legal contract. Therefore, the elements of the CPE program—patient attendees and sponsoring health insurance companies or corporations are interwoven to make this innovation.

The CPE program is different from continuing medical education (CME) or continuing educational units (CEU) in that patients attending the course are not required to complete prerequisite health-related official degrees, but are required to complete the course module, set achievable goals and contractually agree to be re-evaluated, monitored and tracked to ensure progress toward healthy living. Patients attending the CPE program also adopt practices if accountability and responsibility for individuals' own health and decision making in health care. Certifications may be renewed after 1-2 years in order to ensure sustainability of learned health information.

Certification may serve to validate the patient's commitment to engage in healthy living practices and, because incentives (as determined by health insurance carriers or healthcare agencies) are involved in the CPE process, a valid contract must be signed between all parties. Reward and incentives for having met achieved goals and subsequent healthy outcome is the driving force that keeps patients from ceasing favorable healthy practices.

It should be understood, of course, that the foregoing relates to exemplary embodiments of the invention and that modifications may be made without departing from the spirit and scope of the invention as set forth in the following claims.

What is claimed is:

1. A continuation patient education (CPE) program comprising:
at least one CPE program module adapted to provide education to a patient dealing with a health problem;
at least one contract between the patient and a sponsoring organization; and
a certification granted to the patient upon patient completion of the CPE program module.

2. The CPE program of claim 1, wherein each CPE program module is implemented by at least one of a nurse practitioner, a physician and a psychologist.

3. The CPE program of claim 1, wherein further comprising a reward granted to the patient upon completion of the CPE program module.

4. The CPE program of claim 3, wherein completion of the CPE program module is achieved upon completion of the course and achievement of goals after completion of the course.

5. The CPE program of claim 1, further comprising software registries, the software registries adapted to tract certifications and track patient progress.

6. The CPE program of claim 1, wherein the program is implemented over a web-based platform for patient enrollment and tracking.

7. The CPE program of claim 1, wherein the patient has a chronic health issue addressed by the CPE program module.

8. The CPE program of claim 1, further comprising a renewal module for permitting a patient to renewal the certification upon expiration thereof.

9. A method for providing standardized educational certification for patients with chronic illness, the method comprising:
delivering at least one CPE program module to the patient dealing with the chronic illness;
executing a contract between the patient and a sponsoring organization; and
granting a certification to the patient upon patient completion of the CPE program module.

10. The method of claim 9, further comprising granting the patient a reward for successful completion of the CPE program module.
